(19) United States
(12) Patent Application Publication
(10) Pub. No.: US 2020/0288772 A1
(43) Pub. Date: Sep. 17, 2020

(54) ASHTRAY

(71) Applicant: WISE SMOKER LTD., GEDERA (IL)

(72) Inventors: RON EYAL, GEDERA (IL); SHOOLY EYAL, GEDERA (IL)

(21) Appl. No.: 16/766,146

(22) PCT Filed: Dec. 13, 2018
(86) PCT No.: PCT/IL2018/051357

§ 371 Date: May 21, 2020

Related U.S. Application Data
(63) Continuation of application No. 62/598,468, filed on Dec. 14, 2017.

(51) Int. Cl. A24F 19/10; B60H 3/06; A24F 19/02

(52) U.S. Cl. CPC A24F 19/10; A24F 19/0021; A24F 19/02; B60H 3/06

(57) ABSTRACT

An ashtray comprising: a detecting module signally connected to a control module; an air intake module signally connected to the control module; a remnants removal module fluidically connected to the air intake module; and an air exhaust module fluidically connected to the remnants removal module. The ashtray is configured to be installed inter alia in a vehicle. Additional embodiments of the ashtray and its various functions are disclosed herein.

### CROSS-REFERENCE TO RELATED APPLICATION

This application claims priority to U.S. Provisional Patent Application No. 62/598,468, filed Dec. 14, 2017, the entire contents of which is incorporated herein by reference in its entirety.

### FIELD

The present subject matter relates to smoking accessories. More particularly, the present subject matter relates to ashtrays.

### BACKGROUND

Several ashtrays of the prior art provide an air cleaning feature.

DE4316226A1 discloses a vehicle ashtray with a vacuum cleaner to keep the passenger cabin clean and prevent passive smoking.

JP2002017329A discloses a smoke catching cap for placement on an ashtray. The cap comprises an electric fan to suck smoke from a cigarette and a smoker into the cap.

CN201153510Y disclose an ashtray that can automatically suck cigarette ash.

CN204132386U discloses a portable ashtray, including a groove in which smell-purifying pellets are arranged.

### SUMMARY

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided an ashtray 1 comprising: a detecting module 10 signally connected to a control module 20; an air intake module 30 signally connected to the control module 20; a remnants removal module 40 fluidically connected to the air intake module 30; and an air exhaust module 50 fluidically connected to the remnants removal module 40.

According to one embodiment, the remnants removal module 40 is signally connected to the control module 20.

According to another embodiment, wherein the air exhaust module 50 is signally connected to the control module 20.

According to yet another embodiment, the ashtray 1 further comprises an air refreshing module 60 between the remnants removal module 40 to which the air refreshing module 60 is fluidically connected, and the air exhaust module 50 to which the air refreshing module 60 is fluidically connected.

According to still another embodiment, the refreshing module 60 is signally connected to the control module 20.

According to a further embodiment, the detecting module 10 is configured to detect at least one activating signal and in response send a signal to the control module 20 designating that an at least one activating signal has been detected, and the control module 20 is configured to activate the air intake module 10 in response to the activating signal.

According to yet a further embodiment, the air intake module 30 is configured to intake air 700 into the ashtray 1 in a manner that allows the taken-in air 700 to pass through the remnants removal module 40 and then further to the air exhaust module 50, and out of the ashtray 1.

According to still a further embodiment, the air intake module 30 is configured to allow the taken-in air 700 to flow through the air freshening module 60 after the remnants removal module 40 and before the air exhaust module 50.

According to an additional embodiment, air 700 blown out of the ashtray 1 through the air exhaust module 50 is devoid of cigarette remnants.

According to yet an additional embodiment, the air 700 blown out of the ashtray 1 through the air exhaust module 50 is perfumed.

According to still an additional embodiment, the control module 20 comprises a processor 202 and a memory 20.

According to another embodiment, the ashtray 1 is configured to be installed in a vehicle, and clean air in the vehicle.

According to yet another embodiment, the ashtray is further configured to refresh air in the vehicle.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1 schematically illustrates, according to an exemplary embodiment, a block diagram of an ashtray.

FIG. 2 schematically illustrates a block diagram of another exemplary embodiment of an ashtray.

FIG. 3 schematically illustrates a block diagram of yet another exemplary embodiment of an ashtray.

FIG. 4 schematically illustrates a block diagram of still another exemplary embodiment of an ashtray.

FIG. 5 schematically illustrates, according to an exemplary embodiment, a perspective cross-section view of an ashtray.

FIG. 6 schematically illustrates, according to an exemplary embodiment, a perspective view of an ashtray and a receptacle partially removed from the ashtray.

FIG. 7 schematically illustrates, according to an exemplary embodiment, a block diagram of a control module.

FIG. 8 schematically illustrates, according to an exemplary embodiment, a block diagram of components participating in a voice recognition and activation cycle.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

Several embodiments of the subject matter are herein described. It is understood, inasmuch as the described embodiments are examples of the subject matter, that an ashtray with any combination of features presented in one or more of the described embodiments are included in this description of the subject matter.

The present subject matter provides an ashtray configured to detect an activating signal and in response to the activating signal intake air with cigarette remnants like smoke, buts and ash, into the ashtray and release clean air from the ashtray.

According to one embodiment, the activating signal is a cigarette nearby the ashtray. According to another embodiment, the activating signal is a movement of an object nearby the ashtray. According to yet another embodiment, the activating signal is a sound.

According to a further embodiment, the ashtray is configured to remove cigarette remnants, like buts, ash and smoke, from the in-taken air.

According to an additional embodiment, the ashtray is further configured to freshen the clean air before the clean air is released from the ashtray. According to yet an additional embodiment, the ashtray is configured to freshen the clear air by scenting the clear air.

Even though it is mentioned herein that smoke from a cigarette may activate the function of the ashtray, and remnants of a cigarette are removed from the air by the ashtray, it should be noted that the term “cigarette” is only exemplary and used for the sake of simplicity only. The term “cigarette”, as disclosed herein refers to a burning object, particularly burning of tobacco and the like, for example by usage of a smoking product, like a cigarette, a smoking pipe, and the like.

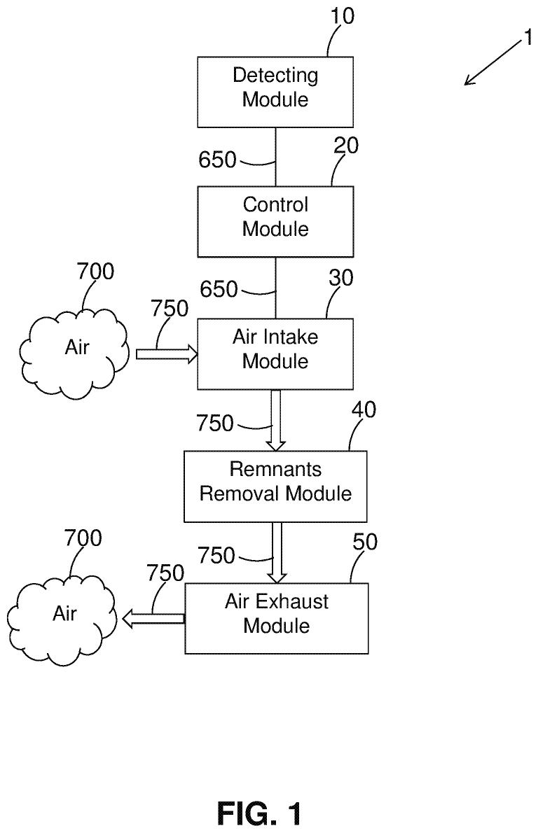

FIG. 1 schematically illustrates, according to an exemplary embodiment, a block diagram of an ashtray. Lines 650 designate signal connection between components. Arrows 750 designate flow of air 700 between components. According to one embodiment, the ashtray 1 comprises a detecting module 10 signally connected to a control module 20; an air intake module 30 signally connected to the control module 20; a remnants removal module 40 fluidically connected to the air intake module 30; and an air exhaust module 50 fluidically connected to the remnants removal module 40.

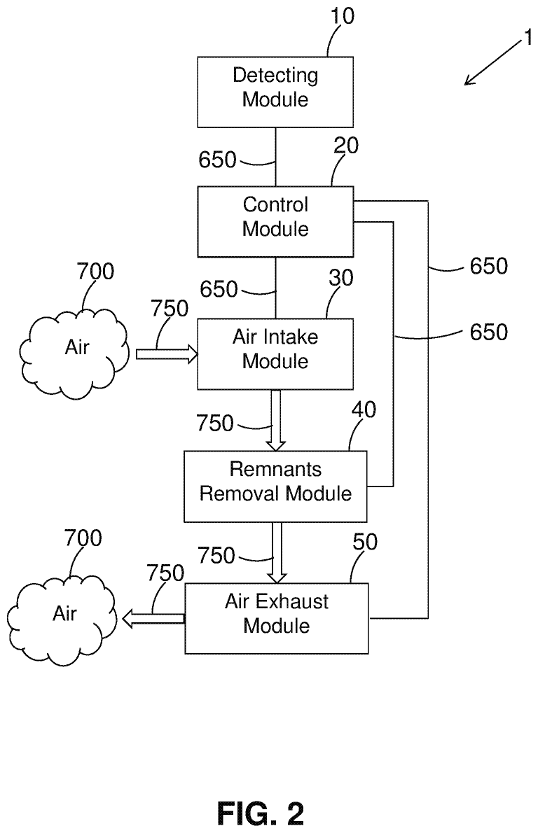

FIG. 2 schematically illustrates a block diagram of another exemplary embodiment of an ashtray. According to one embodiment, the remnants removal module 40 is signally connected to the control module 20 (not shown). According to yet another embodiment, the air exhaust module 50 is signally connected to the control module 20. According to yet another embodiment, both the remnants removal module 40 and the sir exhaust module 50 are signally connected to the control module 20, as illustrated in FIG. 2.

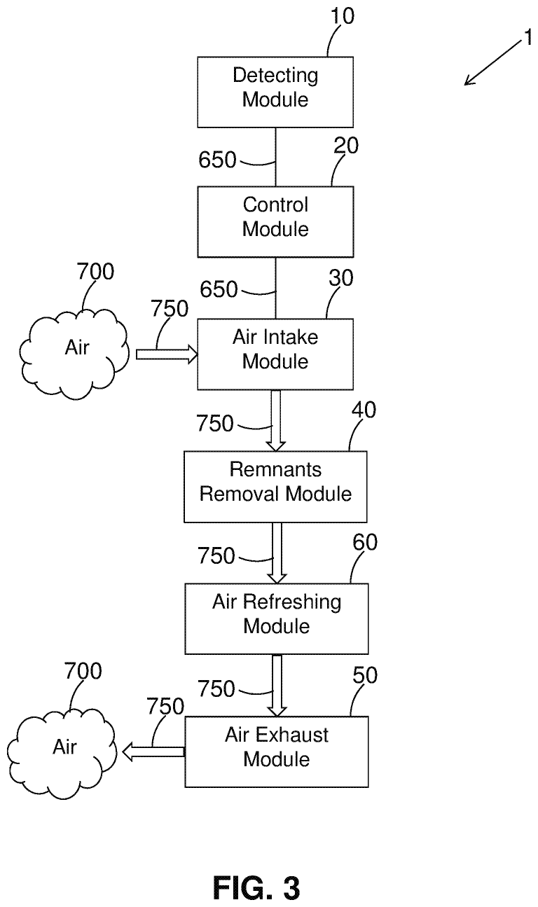

FIG. 3 schematically illustrates a block diagram of yet another exemplary embodiment of an ashtray.

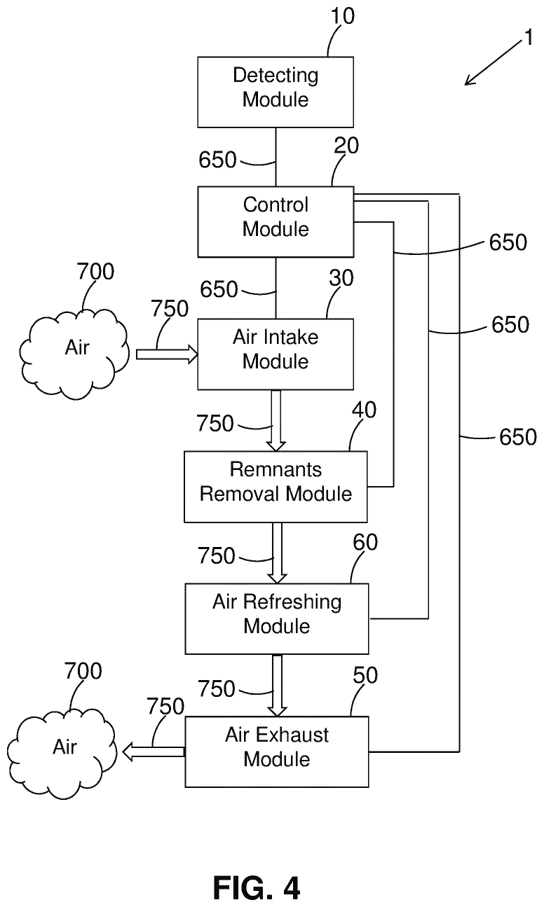

FIG. 4 schematically illustrates a block diagram of still another exemplary embodiment of an ashtray.

According to one embodiment, illustrated in FIG. 3, the ashtray 1 may further comprise an air refreshing module 60 between the remnants removal module 40 to which the air refreshing module 60 is fluidically connected, and the air exhaust module 50 to which the air refreshing module 60 is fluidically connected. According to another embodiment, the refreshing module 60 may be signally connected to the control module 20, as illustrated in FIG. 4. It should be noted that even though FIG. 4 shows a signal connection between the remnants removal module 40, the air exhaust module 50 and the air refreshing module 60 with the control module 20, any combination of signal connection, or no signal connection, between the remnants removal module 40, the air exhaust module 50 and the air freshening module 60 with the control module 20 is under the scope of the present subject matter.

According to one embodiment, the detecting module 10 is configured to detect at least one activating signal and in response send a signal to the control module 20 designating that an at least one activating signal has been detected. According to another embodiment, the detecting module 10 is configured to detect any type of activating signal known in the art. According to yet another embodiment, the detecting module 10 is configured to detect any activating signal that is related to a need to activate the ashtray 1 and cause the ashtray 1 to function, namely operate the air intake module 30 and alternatively operate the air freshening module 60.

According to a further embodiment, the detecting module 10 is configured to detect activating signals that are external to the ashtray 1, as detailed hereinafter. According to yet a further embodiment, the detecting module 10 is configured to detect ashtray 1 internal activating signals, as detailed hereinafter. According to this embodiment, a component of the detecting module 10 may be physically attached to any one of air intake module 30, remnants removal module 40, air exhaust module 50 and air freshening module 60, and any combination thereof (not shown). According to an additional embodiment, the detecting module 10 may be signally connected to any one of air intake module 30, remnants removal module 40, air exhaust module 50 and air freshening module 60, and any combination thereof (not shown).

According to one embodiment, activating signals external to the ashtray 1 include activating signals that are related to a need to activate the ashtray 1, namely intake air 700 into the ashtray 1 by the air intake module 30, remove cigarette remnants from the air 700 taken into the ashtray 1 by the remnants removal module 40 and exhaust clean air 700 from the ashtray 1 by the air exhaust module 50. In another embodiment, the activating signals may be related also to a need to activate refreshing of the air 700 with the air refreshing module 60 after cigarette remnants were removed from the air 700.

According to one embodiment, the detecting module 10 comprises at least one sensor configured to detect an activating signal. Any type of sensor known in the art is under the scope of the present subject matter. Exemplary sensors that may be part of the detecting modules 10 include, but not limited to: proximity sensor, smoke sensor, heat sensor, optical sensor, sound sensor, movement sensor and the like.

According to one embodiment, the detecting module 10 is configured to detect activating signals that are external to the ashtray 1. In this embodiment, the detecting module may comprise at least one of the following exemplary components: a smoke sensor configured to detect smoke, thus indicating that a cigarette is adjacent to the ashtray 1 or that there is smoke in the air that should be cleared from the air; a proximity sensor configured to detect an object adjacent to the ashtray 1, for example detecting a cigarette or a hand of a smoker, thus indicating that a cigarette is adjacent to the ashtray 1; a heat sensor configured to detect heat, thus indicating that a burning cigarette is adjacent to the ashtray 1; an optical detector configured to visually detect objects, thus indicating that a certain object, for example cigarette, is adjacent to the ashtray, or an optical detector configured to visually detect a gesture, for example a hand gesture, thus allowing activation of the ashtray 1 by gestures made by a user, for example by moving his hand, fingers and the like; a sound sensor configured to detect sound, thus allowing a user to activate the ashtray for example by sound commands; a movement sensor configured to detect a movement of an object near the ashtray 1, thus indicating that a cigarette is approaching the ashtray 1, or a movement sensor configured to detect a gesture, for example a hand gesture, thus allowing activation of the ashtray 1 by gestures made by a user, for example by moving his hand, fingers, and the like. It should be noted that the aforementioned components and their functions are only exemplary and should be considered as limiting the scope of the present subject matter.

According to one embodiment, the detecting module 10 is configured to determine a level of smoke in the air adjacent to the ashtray 1, and the control module 20 is configured to activate the ashtray 1 accordingly. For example, when the smoke level is low, the control module 20 is configured to activate the air intake module 30 at a low level, and when the smoke level is high the control module 20 is configured to activate the air intake nodule 30 at a high level so as to more efficiently clear the smoke from the air.

According to one embodiment, the detecting module 10 is configured to detect ashtray 1 internal activating signals, namely signals related to the condition of components of the ashtray 1 as described hereinafter. For example, the detecting module is configured to detect that a container of a perfume, which is part of the air freshening module 60 is about to become empty. An appropriate signal indicating that the perfume container is about to become empty is sent from the detecting module 10 to the control module 20 and in response, the control module 20 activates a means that allows a user to know that there is a need to replace the emptying perfume container with a fresh perfume container, for example by turning on a warning light. It should be noted that this is only an example and should not be considered as limiting the scope of the present subject matter. Additional embodiments of ashtray 1 internal activating signals are described hereinafter.

According to one embodiment, the air intake module 30 is configured to intake air 700 into the ashtray 1 in a manner that allows the taken-in air 700 to pass through the remnants removal module 40 and then further to the air exhaust module 50, and out of the ashtray 1. According to another embodiment, the air intake module 30 is further configured to allow the taken-in air 700 to flow through the air freshening module 60 after the remnants removal module 40 and before the air exhaust module 50. According to yet another embodiment, the air intake module 30 is configured to draw air 700 into the ashtray 1, flow the air 700 through the remnants removal module 40, alternatively though the air freshening module 60, and eventually blow the air 700 out of the ashtray 1 through the air exhaust module 50. According to a further embodiment, the air 700 drawn into the ashtray 1 is normally contaminated with cigarette remnants, for example smoke, ash and the like. According to yet a further embodiment, the air 700 blown out of the ashtray 1 through the air exhaust module 50 is clear, namely devoid of cigarette remnants. According to still a further embodiment, the air 700 blown out of the ashtray 1 through the air exhaust module 50 is in addition fresh, for example due to perfuming of the air by the air refreshing module 60. In other words, the air 700 blown out of the ashtray 1 through the air exhaust module 50 is perfumed.

According to one embodiment, air from a space in the vicinity of the ashtray 1 is taken into the ashtray 1. The space may be any type of space known in the art in which cigarettes and other tobacco products are smoked. Examples of such a space include a space of a vehicle, a space of a room, a space of a hall, a space of a chamber, a space of a smoking room—also known a smoking lounge, and the like. It should be noted that the aforementioned spaces from which air is taken into the ashtray 1 are only exemplary and should not be considered a limiting the scope of the present subject matter. The ashtray 1, then, is configured to be installed in any type of space known in the art, for example in a vehicle, a room, a hall, a chamber, a smoking room and the like. Accordingly, the ashtray 1 is configured to clean, and optionally refresh, air in a vehicle, a room, a hall, a chamber, a smoking room and the like.

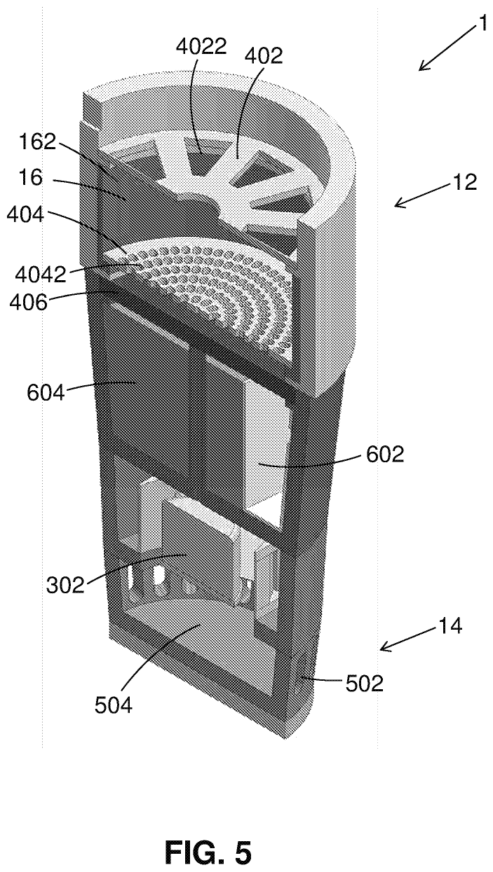

FIG. 5 schematically illustrates, according to an exemplary embodiment, a perspective cross-section view of an ashtray. FIG. 5 illustrates several components of the various modules of the ashtray. It should be noted that each of the components illustrated in FIG. 5 is optional. Therefore, FIG. 5 should be considered as a figure summarizing various optional components of the ashtray 1. In some embodiments, the ashtray 1 may comprise at least one, or some, of the components, while other components are absent.

According to one embodiment, the ashtray 1 has in general a hollow structure comprising an air entry side 12 and an air exit side 14. Components of the various modules of the ashtray 1 reside in an inner space of the hollow structure of the ashtray 1. Air 700 that may contain cigarette remnants, enters into the ashtray 1 in the direction designated with arrow 752 through the air entry side 12; and clean air exits the ashtray 1 in the direction designated with arrow 754. The exiting air 700 may optionally be also freshened. The orientation of the air entry side 12 relative to the air exit side 14 may be any orientation known in the art. For example, the ashtray 1 may be positioned horizontally when the air entry side 12 and the air exit side 14 are substantially at the same level (not shown). Preferably, the orientation of the ashtray 1 is such that the air intake side 12 is substantially above the air exit side 14. According to another preferred embodiment, the ashtray is positioned vertically when the air intake side 12 is substantially above the air exit side 14, as illustrated in FIG. 5.

According to one embodiment, air 700 may enter into the ashtray 1 through a coarse filter 402. The coarse filter 402 is an optional component of the remnants removal module 40, and is configured to remove big objects from the air 700 entering into the ashtray 1. Big objects that may be removed from the air 700 by the coarse filter 402 may include for example cigarettes, cigarette butts, pieces of paper and any object, for example trash, similar in size that may be thrown to the ashtray 1. Accordingly, the coarse filter 402 comprises coarse openings 4022 that prevent passage of the aforementioned big objects, but allow passage into the ashtray 1 of air 700 and fine objects carried by the air 700, for example ash and smoke.

According to another embodiment, at least part of the coarse openings 4022 of the coarse filter 402 allow passage of cigarettes, partial cigarettes and butts, for example in order to allow their passage into a receptacle 16 positioned downstream to the coarse filter 402 and configured to hold trash, for example trash related to smoking, for example partially smoked or broken cigarettes, butts, ash and the like. The receptacle 16 is further described hereinafter.

According to another embodiment, the ashtray may comprise a fine filter 404. The fine filter 404 is a component of the remnants removal module 40, and is configured to remove fine objects from the air 700 flowing in the ashtray 1. In an embodiment where the remnants removing module 40 comprises a coarse filter 402, the fine filter 404 is positioned downstream to the coarse filter 402. Accordingly, air 700 passes first through the coarse filter 402 and then through the fine filter 404. In another embodiment, the fine filter 404 is the first component of the remnants removing module 40 through which air 700 passes in the ashtray 1. Fine objects that may be removed from the air 700 by the fine filter 404 may include for example ash, dust and any object similar in size that may be carried by the air 700. Accordingly, the fine filter 404 comprises fine opening 4042 that prevent passage of the aforementioned fine objects, but allow passage of air 700, smoke particles and similarly-sized particles carried by the air 700. According to a further embodiment, the fine filter 404 is configured to filter ash, namely prevent passage of ash through the fine filter 404. Any type of filter known in the art that is configured to filter ash is under the scope of the present subject matter, for example a high-efficiency particulate arrestance (HEPA) filter, a semi-HEPA filter, a sintered filter made of any suitable material known in the art, for example metal or plastic, and the like.

According to one embodiment, the ashtray 1 may comprise a receptacle 16 configured to hold trash, for example trash related to smoking, for example partially smoked or broken cigarettes, butts, ash and the like. According to one embodiment, the receptacle 16 is positioned downstream the coarse filter 402 and is configured to hold objects, trash and cigarette remnants that pass through the coarse filter 402. According to another embodiment, in which the ashtray 1 does not comprise a coarse filter 402, the receptacle 16 is positioned adjacent to the air entry side 12 of the ashtray 1. According to a further embodiment, the receptacle 16 comprises at least one wall 162 enclosing an interior volume of the receptacle 16. Anything that is accumulated in the receptacle 16 resides in the volume enclosed by the at least one wall 162 of the receptacle 16. It should be noted that an upper side of the receptacle 16 is open. The open upper side of the receptacle 16 is configured to allow entry of rash and cigarette remnants into the receptacle 16.

According to one embodiment, the fine filter 404 is positioned at the bottom of the receptacle 16. Thus, the receptacle 16 is configured to hold trash, particularly smoke related trash, for example cigarettes, partial cigarettes, butts, ash, dust and the like that are filtered by the fine filter 404.

It should be noted again that the ashtray 1 may comprise, according to one embodiment, a coarse filter 402 upstream to the receptacle 16 and a fine filter 404 at the bottom of the receptacle 16. According to another embodiment, the ashtray 1 comprises a fine filter 404 at the bottom of the receptacle 16, while the open upper part of the receptacle 16 is directly open to the air. According to yet another embodiment, the ashtray 1 does not comprise a receptacle, but one of the following options: a coarse filter 402, a fine filter 404, or a coarse filter 402 positioned above a fine tilter 404.

According to one embodiment. the receptacle 16 is permanently positioned in the ashtray 1. According to another embodiment, the receptacle 16 is configured to be removed from the ashtray 1.

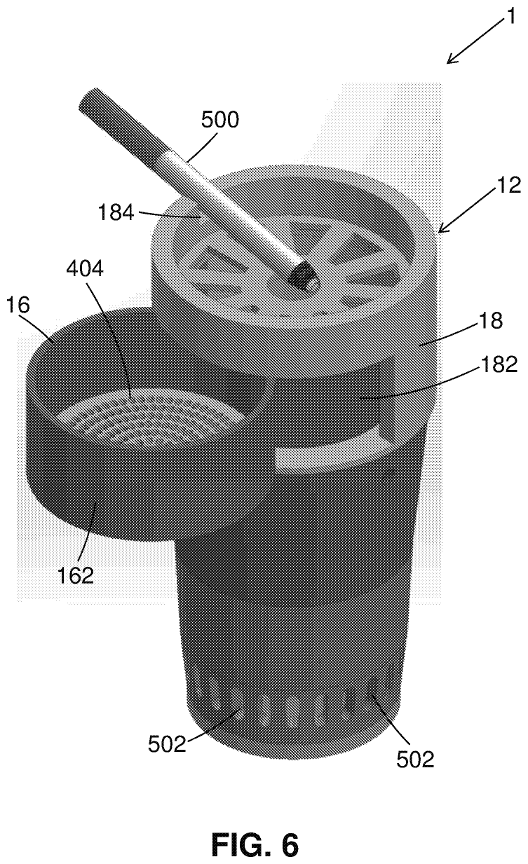

FIG. 6 schematically illustrates, according to an exemplary embodiment, a perspective view of an ashtray and a receptacle partially removed from the ashtray. According to this embodiment, the receptacle 16 is configured to be removed from the ashtray 1, for example in order to dispose cigarette remnants, or other objects accumulated in the receptacle 16. According to another embodiment, the receptacle 16 is configured to be returned to its place in the ashtray 1. According to yet another embodiment, the receptacle 16 is reusable, namely the receptacle 16 may be used multiple types—when in need to empty the reusable receptacle 16, it is removed from the ashtray 1, emptied and returned to the ashtray 1. According to still another embodiment, the receptacle is disposable, namely used once. When there is a need to empty the disposable receptacle 16, it is removed and discarded, and a fresh empty disposable receptacle 16 is placed in the ashtray, as illustrated in FIG. 1. According to these embodiments, that the receptacle 16 is configured to be removed from the ashtray 1, the ashtray 1 may comprise an opening 182 in an outer wall 18 of the ashtray 1, through which the receptacle may be removed from the ashtray 1 and returned to the ashtray 1.

According to one embodiment, the receptacle 16 may comprise at least one fullness sensor configured to sense level of fullness of the receptacle 16. The at least one fullness sensor is part of the detecting module 10 configured to detect an internal activating signal. Any type of fullness sensor configured to sense level of fullness of the receptacle 16 is under the scope of the present subject matter. One example is a contact sensor, positioned for example at a certain height in the receptacle 16. Once trash accumulated in the receptacle touches the contact sensor, the contact sensor transmits a signal to the control module 20 designating that the receptacle 16 is full. Another example of a fullness sensor is a photovoltaic cell configured to detect light emitted towards it from a light source. Once light cannot reach the photovoltaic cell because it is blocked by trash in the receptacle 16, the photovoltaic cell transmits a signal to the control module 20 designating that the receptacle 16 is full.

According to one embodiment, the ashtray 1 comprises an air filter 406, which is a component of the remnants removal module 40. The air filter 406 is positioned downstream to the fine filter 404. Therefore, air 700, gases and particles mixed with the air 700 that pass the fine filter 404 flow towards and then through the air filter 406. The air filter 406 is configured to trap smoke particles, or any other particles similar in size. Therefore, air 700 that exits the air filter 700 is devoid of smoke particles and other particles similar in size. Any type of air filter 406 that is configured to trap smoke particles, or any other particles similar in size, is under the scope of the present subject matter, for example carbon filter and the like. According to one embodiment, the air filter 406.

According to one embodiment, the air filter 406 is permanent, namely the air filter 406 is permanently used. According to another embodiment, the air filter 406 is disposable, namely used until there is a need to replace the air filter 406. In this embodiment, a used air filter 406 is removed from the ashtray 1 and a fresh air filter 406 is placed instead.

According to one embodiment, the air filter 406 may comprise at least one sensor configured to detect the level of contamination of the air filter 406, indicating that it is time to discard the used air filter 406 and replace it with a new one. Any sensor known in the art that is configured to detect the level of contamination of an air filter 406, namely a sensor configured to determine the level of smoke particles trapped in the air filter 406, is under the scope of the present subject. When the air filter 406 sensor detects a contamination level of the air filter 406 at a predetermined threshold level, the sensor transmits a signal to the control module 20 designating that the air filter 406 is full.

Another means for determining the time in which it is necessary to replace the sir filter is by using a timer. For example, it is known that the air filter 406 should be replaced at certain time intervals, for example every month. Accordingly, the timer counts the time passing since a fresh air filter 406 is installed in the ashtray 1. Once a predetermined time period has be reached, for example one month, the timer transmits a signal to the control module 20 indicating that it is time to replace the air filter 406.

According to one embodiment, the ashtray 1 comprises at least one air intake element that is configured to force entry of air 700 into the ashtray through the air entry side 12, flow of the air 700 inside the ashtray 1 and through components of the remnants removal module 40 and alternatively through the air refreshing module 60, as well as exit of the air 700 from the ashtray 1 through the air exit side 14. Thus, the air intake element is part of the air intake module 30. Any type of air intake element that is configured to perform the aforementioned functions is under the scope of the present subject matter. An exemplary air intake element, shown in FIG. 5, is a fan 302. The fan 302 is configured to perform the aforementioned functions of the air intake element. According to the embodiment shown in FIG. 5, the ashtray 1 comprises a fan 302. According to another embodiment, the ashtray 1 comprises at least one fan 302. According to yet another embodiment, the ashtray 1 comprises at least one fan 302 and at least one another type of an air intake element.

According to one embodiment, the air intake element may be positioned in any position in the ashtray 1. According to a preferred embodiment, illustrated in FIG. 5, the air intake element, in a form of a fan 302, is positioned downstream relative to the air filter 406, and optionally downstream to a component of the air freshening module 60 that is described hereinafter.

According to one embodiment, the operation of the air intake element may be controlled by the control module 20. For example, the air intake element may be activated when a smoke sensor, for example, detects smoke in the air in the vicinity of the ashtray 1. As a result, a signal is transmitted from the smoke sensor to the control module 20 indicating that smoke was detected in the vicinity of the ashtray 1. As a result, the control module 20 transmits a signal to the air intake element to start operating, namely taking air 700 into the ashtray 1 in order to clean the air from smoke and other pollutants by components of the remnants removal module 40, and optionally refreshing the air 700 by the air refreshing module 40. In an embodiment where the air intake element is a fan 302, the operation of the fan 302 is controlled as described above.

According to another embodiment, the level of operation of the air intake element may be controlled by the control module 20. For example, when the air intake element is a fan 302, the speed of operation of the fan 302 may be controlled by the control module 20. An example of such a control may be control of the speed of the fan 302 according to the level of smoke in the air in the vicinity of the ashtray 1 that is detected by a smoke sensor. A signal indicating the level of smoke is transmitted from the smoke sensor to the According to one embodiment, the ashtray 1 comprises an air exhaust chamber 504.

Thus, the air exhaust chamber 504 is part of the air exhaust module 50. According to another embodiment, the air exhaust chamber 504 is configured to receive clean air 700 after the air 700 passed through components of the remnants removal module 40, and alternatively receive refreshed air 700 after it passed through components of the air refreshing module 60 and then allows the clean, and alternatively fresh, air 700, to exit the ashtray 1. Accordingly, the air exhaust chamber 504 resides adjacent to the air exit side 14 of the ashtray 1. According to one embodiment, the air 700 exits the air exhaust chamber 504 through at least one exhaust opening 502 in a wall of the ashtray 1 closing the air exhaust chamber 504, in the air exit side 14 of the ashtray, as illustrated in FIGS. 5-6.

According to one embodiment, the ashtray 1 may comprise an air freshening module 40 configured to freshen air 700 passing through or nearby the air freshening module 60. The air freshening module 60 is configured to freshen the air 700, for example by perfuming the air. According to this embodiment, the ashtray 1 may comprise a perfume container 602, configured to store a perfume and release the perfume to the air 700. Thus, the perfume container 602 is part of the air freshening module 60. Any perfume known in the art in any state known in the art—solid, liquid or gas, is under the scope of the present subject matter. The perfume may be added to the air 700 flowing through ashtray 1 in any mechanism known in the art, for example allow a solid perfume to sublimate to the air, spraying aerosols of a liquid perfume, releasing a gaseous perfume from the perfume container 602, and the like. According to an additional embodiment, the air freshening module 60 may further comprise a perfuming element 604 configured to allow mixing of air 700 with the perfume. An exemplary perfuming element 604, shown in FIG. 6, is a sponge 604 configured to absorb a perfume, preferably a liquid perfume, released from the perfume container 602, and allow mixing of the perfume with air 700 flowing through, or adjacent to, the sponge 604. Another exemplary perfuming element 604 is a spraying element fluidically connected to a perfume container 602 containing a liquid perfume. The spraying element (not shown) is configured to spray perfume aerosols into the air 700 flowing near the spraying element. It should be noted that the sponge and the spraying element are only examples of the perfuming element 604 and should be considered a limiting the scope of the present subject matter. Any type of a perfuming element 604 known in the art is under the scope of the present subject matter.

According to one embodiment, the perfume container 602 is configured to be used multiple times. In other words, the perfume container 602 is configured to be refilled with perfume when there is a need to replenish the perfume container 602 with perfume. According to another embodiment, the perfume container 602 is disposable. In other words, when the perfume container 602 becomes empty it is removed from the ashtray 1 and a fresh perfume container 602 containing perfume is inserted instead of the empty perfume container 602. According to this embodiment, the perfume container 602 may comprise a perfume level sensor configured to sense the level of perfume in the perfume container 602. When the perfume level in the perfume container 602 reaches a predetermined level, or when no perfume is detected in the perfume container 602, a signal is transmitted from the perfume level sensor to the control module 20 indicating that the level of perfume in the perfume container 602 has reached the predetermined level, or that the perfume container 602 is empty, and in turn the control module 20 may for example start an alarm of any type known in the art, indicating that there is a need to refill the perfume container 602, or replace the empty perfume container 602 with a fresh full perfume container 602. According to yet another embodiment, the perfume container 602 may be replaced as described above on a timely basis. For example, a timer counts the times passing since a fresh perfume container 602 is installed in the ashtray 1. When a predetermined period of time passes, for example a month, an alarm of any type known in the art, is started—indicating that there is a need to replace the perfume container 602. Similar embodiments apply also to the perfuming element 604.

According to one embodiment, the entire air refreshing module 60 is in the form of a replaceable cassette, or cartridge, that is configured to be removed and replaced according to the aforementioned embodiments relating to the perfume container 602 and the perfuming element 604.

According to one embodiment, the ashtray 1 may comprise at least one light source 702 configured to emit light. The at least one light source 702 may be positioned anywhere on the ashtray 1. According to a preferred embodiment, the at least one light source 702 may be positioned on an edge of an upper opening of the ashtray 1, at the air entry side 12 of the ashtray 1. According to another preferred embodiment, the light source 702 may have a ring-like structure positioned on at least part of the edge of the upper opening of the ashtray 1, or alternatively multiple light source 702 may be arranged in a ring-like structure positioned on at least part of the edge of the upper opening of the ashtray 1. Any type of light source 702 known in the art, emitting light in any color known in the art, is under the scope of the present subject matter. Some exemplary types of light source 702 include an incandescent lamp, a fluorescent lamp, a halogen lamp, a light-emitting diode (LED) and the like, and any combination thereof.

According to one embodiment, the light source 702 is configured to serve as a decoration for the ashtray 1. According to another embodiment, the light source 702 is configured to allow a user, for example a smoker, to visually notice the ashtray 1, for example when it is dark. According to one embodiment, the light source 702 is configured to permanently emit light. According to another embodiment, all aspects of light emission by the light source 702, for example duration of light emission, light intensity, color of emitted light, color pattern of the emitted light and the like, may be controlled. According to another embodiment, all aspects of light emission by the light source 702 may be controlled by the control module 20. According to yet another embodiment, all aspects of the light emission by the light source 702 may be controlled in response to activating signals detected by the detecting module 10 in a manner described above. For example, detection of a lit cigarette in the vicinity of the ashtray 1, for example by a heat sensor, cause the heat sensor to transmit a signal to the control module 20 indicating that a lit cigarette is adjacent to the ashtray 1. In response to this signal received by the control module 20, the control module 20 mat send a signal to the light source 702 to start emitting light. Similarly, when the cigarette is removed from the vicinity of the ashtray 1, the emission of light by the light source 702 may be shut-off as a result of a similar sequence of events. It should be noted though, that this is only an example of the way in which light emission by the light source 702 may be controlled by the control module 20, and that any type of control pattern known in the art is under the scope of the present subject matter.

It should be obvious to a person skilled in the art that in light of the aforementioned embodiments, the light source 702 may be signally connected to the control module 20.

It should be further understood that the ashtray 1 may comprise a power source configured to supply power for the light source 702. Not only that, the power source may be configured to supply electrical energy to any component of the ashtray 1 that may require supply of electrical energy, for example components of the control module 20, the air intake element, for example the fan 302, and the like. Any type of power source known in the art is under the scope of the present subject matter, for example a battery, a photoelectrical cell, and the like.

According to one embodiment, illustrated in FIG. 6, the ashtray 1 may comprise at least one notch 184 on the edge of the upper opening of the ashtray 1, at the air entry side 12 of the ashtray 1. Each notch 184 is configured to hold a cigarette 500.

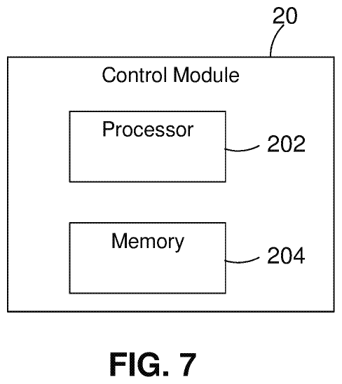

FIG. 7 schematically illustrates, according to an exemplary embodiment, a block diagram of a control module. According to one embodiment, the control module 20 may comprise a processor 202. Any processor 202 known in the art is under the scope of the present subject matter, for example a central processing unit (CPU). According to another embodiment, the control module 20 may further comprise a memory 204. Any memory 204 known in the art is under the scope of the present subject matter, for example a machine-readable medium, also known as computer-readable medium (CRM). The memory 204 is configured to store data, and the processor 202 is configured to process data. The control module 20 as a whole is configured to receive data or signals, process data and transmit data or signals, as known in the art.

According to one embodiment, the control module 20 is configured to read activating signals received from components, for example sensors, of the detecting module 10. According to another embodiment, the control module 20 is configured to adjust activity of the air intake module 30, and alternatively the activity of the air refreshing module 60, in response to activating signals received from the detecting module 10. For example, in response to an activating signal indicating that there is a cigarette adjacent to the ashtray 1, that is received from the detecting module 10, the control module transmits a signal to the air intake module 30 that causes the air intake module 30 to start taking in air 700, for example by starting the action of a fan 302 that was in rest. In another example, the air intake module 30 takes air 700 into the ashtray 1 continuously. When the detecting module 10 detects a cigarette adjacent to the ashtray 1, the detecting module 10 transmits a signal to the control module 20, and in turn the control module 20 transmits a signal to the air intake module 30 to increase the speed of taking air 700 into the ashtray 1, for example by increasing the rotation speed of a fan 302, in order to enhance the purification of the air 700, which contains a larger amount of smoke due to the cigarette. According to another embodiment, the control unit 20 determines the duration of activity of the air intake module 30, for example the duration of activity of the air intake module 30 after a cigarette is removed from the vicinity of the ashtray 1. Similarly, according to yet another embodiment, the control module 20 controls changes in speed of taking in air by the air intake module 30 in response to changes in conditions detected by the detecting module 10, for example decreasing the rotation speed of the fan 302 in response to detecting a decrease in the level of smoke in the air 700.

According to an additional embodiment, the control module 20 is configured to control the activity of the light source 702. For example, the control module 20 may switch the light source 702 on and off, or control the intensity of light emitted from the light source 702, and a combination thereof, in response to signals received from the detecting module 10. In another example, a light sensor of the detecting module 10 detects that the area of the ashtray 1 is dark. A corresponding signal is transmitted from the detecting module 10 to the control module 20, and in turn the control module 20 transmits a signal to the light source 702 causing the light source 702 to turn on.

According to a further embodiment, an audio signal may be received by a microphone, which is a component of the detecting module 10. For example the audio signal may be a voice command to activate the air freshening module 60. In turn, the detecting module 10 transmits a corresponding signal to the control module 20, and in response the control module 20 transmits a signal to the air freshening module 60 to release perfume to the air 700 passing through it or adjacent to it.

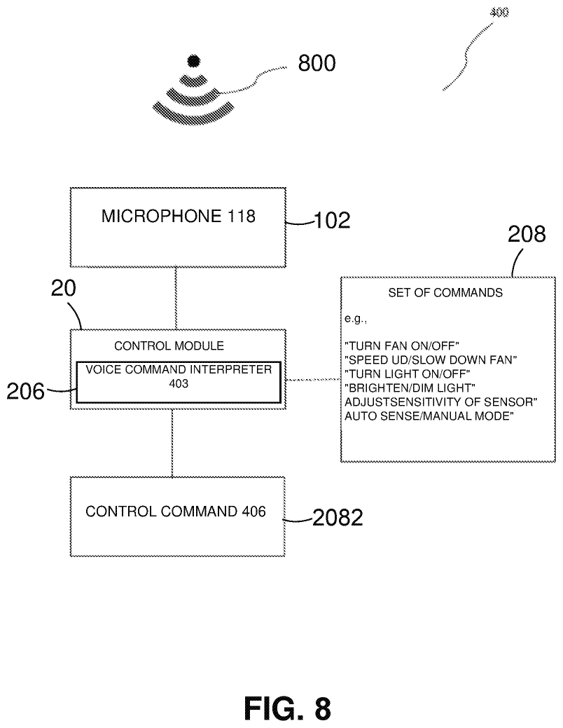

FIG. 8 schematically illustrates, according to an exemplary embodiment, a block diagram of components participating in a voice recognition and activation cycle. According to one embodiment, the detecting module 10 comprises a microphone 102 configured to receive a voice command 800, for example from a user, and convert the voice command 800 to a voice command electronic signal corresponding to the voice command 800. According to this embodiment, the control module 20 comprises a voice command interpreter 206 configured to interpret the voice command electronic signal; and a set of commands 208, stored for example in the memory 204. Once the voice command interpreter 206 receives the voice command electronic signal from the microphone 102, the voice command interpreter 206 interprets the voice command electronic signal, and selects from the set of commands a control command 2082 that corresponds to the voice command 800. Once an appropriate control command 2082 is selected from the set of commands 208, the control module 20 controls a component of the ashtray 1 accordingly. For example, when the voice command 800 is “turn light on”, in response to the selected corresponding control command 2082 the control module 20 transmits a signal to the light source 702 prompting the light source 702 to turn on.

Some exemplary control commands 2082 that are part of the set of commands 208 include: “Turn fan on”, “Turn fan off”, “Speed up fan”, “Slow down fan”, “Turn light on”, “Turn light off”, “Brighten light”, “Dim light”, “Increase sensitivity of sensor”, “Decrease sensitivity of sensor”, “Autosense mode”, “Manual mode” and the like. It should be noted that this list of control commands 2082 which are part of the set of commands 208 is only exemplary, and that any type of control command 2082 is under the scope of the present subject matter.

Regarding the exemplary control commands 2082 “Increase sensitivity of sensor” and “Decrease sensitivity of sensor”, they may be relevant to a situation when a user wishes to adjust the sensitivity of a sensor, for example a sensor configured to detect a cigarette in the vicinity of the ashtray 1. For example, a user wants the fan 302 will be turned on when a cigarette is in a large distance from the ashtray 1. Thus, the user sends the voice command “Decrease sensitivity of sensor”. As a result, the corresponding control command 2082 that is selected from the set of commands 208 causes the sensor to decrease the sensitivity of the sensor, and as a result the sensor detect a cigarette when it is in a large distance from the ashtray 1. Similarly, the control command 2082 “Increase sensitivity of sensor” causes ultimately the sensor to detect a cigarette which is in a closer vicinity to the ashtray 1.

According to one embodiment the set of commands 208 may include control commands 2082 for stopping or starting an automatic operation of a component of the ashtray 1, for example the fan 302. For example, a user may transmit a voice command 800 saying “Automatic fan” in order to start an automatic operation of the fan 302, which adjusts the speed of rotation of the fan 302 according to conditions in the vicinity of the ashtray 1. In another example, the set of commands 208 may include control commands 208 for selecting a mode of a program for automatic adjustment of a speed of rotation of a fan 302. For example, a user may transmit the voice command 800 “continuous fan speed” or “Two-speed fan” to specify whether the fan 302 operate continuously, or alters between two predetermined speed level of rotation in response to conditions in the vicinity of the ashtray 1.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An ashtray comprising:
a detecting module signally connected to a control module;
an air intake module signally connected to the control module;
a remnants removal module fluidically connected to the air intake module; and
an air exhaust module fluidically connected to the remnants removal module.

2. The ashtray of claim 1, wherein the remnants removal module is signally connected to the control module.

3. The ashtray of claim 1, wherein the air exhaust module is signally connected to the control module.

4. The ashtray of claim 1, further comprising an air refreshing module between the remnants removal module to which the air refreshing module is fluidically connected, and the air exhaust module to which the air refreshing module is fluidically connected.

5. The ashtray of claim 4, wherein the refreshing module is signally connected to the control module.

6. The ashtray of claim 1, wherein the detecting module is configured to detect at least one activating signal and in response sends a signal to the control module designating that the at least one activating signal has been detected, and wherein the control module is configured to activate the air intake module in response to the activating signal.

7. The ashtray of claim 1, wherein the air intake module is configured to intake air into the ashtray in a manner that allows taken-in air to pass through the remnants removal module and then to the air exhaust module, and out of the ashtray.

8. The ashtray of claim 7, wherein the air intake module is configured to allow the taken-in air to flow through the air freshening module after the remnants removal module and before the air exhaust module.

9. The ashtray of claim 1, wherein air blown out of the ashtray through the air exhaust module is devoid of cigarette remnants.

10. The ashtray of claim 4, wherein the air blown out of the ashtray through the air exhaust module is perfumed.

11. The ashtray of claim 1, wherein the control module comprises a processor and a memory.

12. The ashtray of claim 1, wherein the ashtray is configured to be installed in a vehicle, and clean air in the vehicle.

13. The ashtray of claim 12, wherein the ashtray is further configured to refresh air in the vehicle.
